(19) United States
(12) Patent Application Publication
(10) Pub. No.: US 2017/0102938 A1
(43) Pub. Date: Apr. 13, 2017

(54) IDENTIFYING A POTENTIAL MENTOR FOR A COMPUTER-ADMINISTERED TEST

(71) Applicant: Dell Products L.P., Round Rock, TX (US)

(72) Inventors: Jake Seigel, Halifax (CA); Derek Alfred Jury, Beechville (CA); Sohail Ali, Halifax (CA)

(21) Appl. No.: 14/879,657

(22) Filed: Oct. 9, 2015

(51) Int. Cl. G06F 9/44; G06F 3/0484

(52) U.S. Cl. CPC G06F 8/71; G06F 3/0484

(57) ABSTRACT

In some implementations, a software application may be changed from a standard mode to a tutorial mode, decoupling a user interface of the software application from a standard mode portion of the software application that provides a standard functionality and coupling the user interface to a tutorial mode portion of the software application that provides a tutorial functionality. The software application may administer a test associated with a tutorial, and determine results associated with the test. The software application may determine that the results fail to satisfy a threshold, obtain data identifying a set of one or more mentors knowledgeable about the test, and display the data. The data may include contact information associated with individual mentors of the set of mentors. The software application may automatically initiate a communication session between a computing device executing the software application and a computing device associated with one of the mentors.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When a software company creates new software or modifies existing software, the company may offer computer-based training to familiarize users with the user interface and functions of the new or modified software. After undergoing the computer-based training, users may begin using the software. However, when using the software in a “live” system (e.g., a system that is in use), any mistakes that the user makes may cause problems in the system, which may adversely impact the business that uses the system. For example, an inexperienced user may accidently delete crucial data, causing delays while the data is restored from a backup etc. In addition, the computer-based training may not be thorough and may have gaps in the training.

### SUMMARY

This Summary provides a simplified form of concepts that are further described below in the Detailed Description. This Summary is not intended to identify key or essential features and should therefore not be used for determining or limiting the scope of the claimed subject matter.

In some implementations, a software application may be changed from a standard mode to a tutorial mode, decoupling a user interface of the software application from a standard mode portion of the software application that provides a standard functionality and coupling the user interface to a tutorial mode portion of the software application that provides a tutorial functionality. The software application may administer a test associated with a tutorial, and determine results associated with the test. The software application may determine that the results fail to satisfy a threshold, obtain data identifying a set of one or more mentors knowledgeable about the test, and display the data. The data may include contact information associated with individual mentors of the set of mentors. The software application may automatically initiate a communication session between a computing device executing the software application and a computing device associated with one of the mentors.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating an architecture to identify one or more potential mentors according to some embodiments.

FIG. 2 is a block diagram illustrating an architecture to display mentor data according to some embodiments.

FIG. 3 is a flowchart of a process that includes determining a potential mentor for a test based on a database of test results according to some embodiments.

FIG. 4 is a flowchart of a process that includes determining a sufficient number of potential mentors for a test according to some embodiments.

FIG. 5 is a flowchart of a process that includes modifying a mode of a software application from a standard mode to a tutorial mode according to some embodiments.

FIG. 6 is a flowchart of a process that includes determining a set of mentors according to some embodiments.

FIG. 7 is a flowchart of a process that includes filtering a set of users based on one or more criteria according to some embodiments.

FIG. 8 illustrates an example configuration of a computing device that can be used to implement the systems and techniques described herein.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices, as well as various input and output (I/O) devices, such as a keyboard, a mouse, touchscreen and/or video display. The information handling system may also include one or more buses operable to transmit communications between the various hardware components.

To help users learn to use a user interface (UI) of a software application, the software application may be designed with at least two portions of software code, e.g., a first portion to provide standard functionality and a second portion to provide tutorial functionality. In a standard mode, the UI may be coupled to the standard functionality (and decoupled from the tutorial functionality) such that the user may use the UI to perform standard operations, e.g., the user may make changes to a computing system (e.g., an enterprise network) that is being used by multiple users. In a tutorial mode, the UI may be coupled to the tutorial functionality (and decoupled from the standard functionality) such that the user may use the UI to perform various operations to mock data, e.g., without affecting a computing system (e.g., an enterprise network) that is being used by multiple users. Thus, in the tutorial mode, the user is able to use the actual UI (e.g., rather than a simpler “dumbed down” version of the UI designed for use in a tutorial) but without causing changes to an in-use computing system.

To further enhance the effectiveness of the tutorial mode, the tutorial mode may provide multiple tutorials and multiple tests to determine whether a user has grasped the concepts described in the tutorial. For example, the tutorial may include multimedia content, such as audio content, video content, text-based content, visual content overlaid onto the UI, another type of multimedia content, or any combination thereof. For example, the visual content overlaid onto the UI may include highlighting a portion of the UI, displaying a drop down menu and illustrating how selecting an item in the drop down menu causes the selected item to visually change in appearance, etc.

After a tutorial regarding a particular aspect of the functionality of the software application has completed, the tutorial mode portion of the software application may administer a test requesting the user to use the UI to perform a particular function (e.g., “use the UI to enable logging when this particular table is accessed to create an audit trail”). The software application may receive user input manipulating the UI to perform the particular function and determine whether the user input will cause the particular function to be performed. If the software application determines that the user input will cause the particular function to be performed, the software application may determine that the user has “passed” the test and present a next tutorial followed by a next test. If the software application determines that the user input will not cause the particular function to be performed, the software application may determine that the user has “failed” the test and execute a remedial portion of the tutorial software. For example, the remedial actions may include replaying the media content associated with the tutorial and re-administering the test, replaying additional media content associated with a second tutorial (e.g., content that provides a different approach compared to the previously presented tutorial) and re-administering the test, identifying one or more mentors who have previously passed the test associated with the tutorial, another type of remedial action, or any combination thereof.

The mentors may be identified by determining information associated with a user that is interacting with the tutorial, data associated with users who have passed a test associated with the tutorial, and filtering the users based on one or more criteria to identify potential mentors. User data associated with a user who is interacting with the tutorial mode of the software application (e.g., the user who took the test and did not pass) may be determined, such as an office location associated with the user, an office location associated with a computing device that is executing the tutorial mode of the software application, a department in a company in which the user works, a manager of the user, other user-related information, or any combination thereof. After a user passes the tests associated with the tutorials, the test results along with information associated with the individual users may be stored in a database at a server. The computing device executing the software application may send information associated with the user and the test that the user took and failed to the server. The server may determine potential mentors by identifying users in the database that have previously passed one or more of the tests that the user took and filtering the users based on one or more criteria. The criteria may include a geographic location of the potential mentor, a distance between the location of the potential mentor and the location of the user (e.g., who is interacting with the tutorial mode), whether the potential mentor has a same manager as the user, whether the potential mentor is in a same department as the user, whether the potential mentor is located in a same building (or floor of a building) as the user, whether the potential mentor answers questions associated with the software application, another type of criteria, or any combination thereof. For example, determining whether the potential mentor answers questions associated with the software application may include analyzing communications (e.g., emails, instant messages, video conferences, etc.) associated with the potential mentor to determine how many of the communications are related to answering a question associated with the software application. To illustrate, if multiple emails to the potential mentor include a name of the software application along with at least one question, there may be high likelihood that the potential mentor may frequently receive questions associated with using the software application. Thus, for example, a potential mentor who has received more than a threshold number (or a threshold percentage) of emails that include a reference to the software application (e.g., a reference to the name or to a particular function of the software application) may be selected as a potential mentor for the user.

After identifying a set of potential mentors for the user that has taken one or more tests, the server may gather data associated with each potential mentor, such as the name, contact information (e.g., email, phone number, video chat identifier, etc.), manager, department number, corporate location (e.g., building, floor, etc.), and other information associated with each potential mentor and send the data to the computing device that is executing the software application in the tutorial mode. The software application may display the data associated with the set of potential mentors on a display device (e.g., monitor) connected to the computing device that is executing the software application. The software application may automatically attempt to initiate a communications session with a potential mentor. If a mentor in the set of potential mentors is unavailable, the software application may automatically attempt to initiate a communications session with a next potential mentor and so on until (i) a communications session is established with one of the potential mentors or (ii) the software application has attempted to initiate a communications session with each mentor in the set of potential mentors.

The mentor data may be displayed in a user interface that includes a function to override the software application automatically attempting to initiate a communications session. For example, the function may enable the user to manually initiate a communications session (e.g., phone call, video conference, chat session using instant messaging etc.) with individual mentors. For example, in response to a user selecting a UI element to initiate a communications session, the software application may initiate a communications session, such as a voice call (e.g., using voice over internet protocol (VoIP)), a video call session (e.g., using Skype® or other video call application using session initiation protocol (SIP)), an instant messaging (IM) based chat session, or other type of communications session. For example, the user may recognize one or more of the potential mentors as someone that the user knows (e.g., the user has previously interacted with one of the potential mentors) and desire to initiate a communications session with a known potential mentor rather than having the software application automatically initiate a communications session with a potential mentor that the user does not know.

For example, a user may desire to learn how to purge records using a software application (e.g., Dell® Change Auditor® software). The purge feature of the software application may create a scheduled task to clean particular records stored in a database. Using the purge feature may involve attention to detail to correctly set up the purge feature to purge only the intended records and avoid unintentionally purging important records. The user may initiate a tutorial mode for the software application in which the software application presents the user with a multimedia (e.g., one or more of audio, video, or text) tutorial describing how to purge records. The software application may administer a test to the user to determine if the user has understood the material presented in the tutorial. The software application may grade the test and record the test results. If the test results indicate that the user has not fully understood the material presented in the tutorial, the software application may provide the user with additional help in understanding the purge feature by identifying one or more mentors, e.g., peers who are knowledgeable about setting up the purge feature. The software application may automatically initiate a communications session between the user and the mentor.

| User Actions | Software Application Response |
|---|---|
| User launches a user interface (e.g., web | The software application couples the user |
| interface) for a software application, selects | interface to the tutorial mode and decouples |
| tutorial mode, and selects a particular | from the standard mode to prevent the user |
| tutorial (e.g., tutorial for a purge feature). | from affecting data in an in-use computing |
| | system when performing actions in tutorial |
| | mode. The tutorial (e.g., associated with the |
| | purge feature) may be presented. |
| The user provides a selection indicating that | The software application engages the user in |
| the user is ready to take a test on the topic of | a test by providing tasks for the user to |
| the tutorial. | accomplish and by providing a help menu. |
| | The software application may provide tips |
| | or hints when requested by the user. |
| The user completes the tasks using the | The software application determines a score |
| software application's user interface. | associated with the test and displays the test |
| | results. For example, the software |
| | application may determine that the user has |
| | incorrectly used the purge feature. |
| The user views the test results and is still | The system determines one or more mentors |
| unclear on how to correctly perform the task | (e.g., knowledgeable peers) in the |
| being tested. The user provides a selection | organization, displays the mentors, and |
| requesting a mentor. | automatically initiates a communications |
| | session with one of the mentors. |
| The user and the mentor communicate with | After the user has passed the test, the |
| each other during the communications | software application decouples the UI from |
| session. The user may re-take the test (e.g., | the tutorial mode and couples the UI to the |
| either during the communications session or | standard mode to enable the user to affect |
| after the communications session). | an in-use computing system. |

Thus, tutorials may help users learn a user interface associated with a software application. After a tutorial has completed, the software application may administer a test to determine if the user has understood the material presented in the tutorial. The software application may enable the user to connect with a knowledgeable peer within the company (and likely somebody in the same area of the organization) who can explain the concepts to the user in a manner in which a computer-administered tutorial may not be able to do. For example, software systems, such as software interfaces for cloud products, may be expensive to set up and/or expensive to use. While learning how to use a product, the user may incur fees, charges, or even damage the system (e.g., by inadvertently changing crucial parameters and causing a system failure). Typically, in a conventional system, finding the right person with the right expertise and using them as a learning aid is left up to the user. The software application grades a user's ability to perform a test and provide the ability to connect the user to a knowledgeable peer within the company who can aid them (and likely somebody in the same area of the organization). A software application may provide a UI that can be decoupled from the standard functionality and coupled to a tutorial functionality in a tutorial mode in which the user interacts with mock data rather than a computing system that is being used by other users. The tutorials may be enhanced by enabling a user struggling with a function of the software application to be connected with a user who has mastered the function. Identifying potential mentors may include identifying a set of users who have passed the test (or tests) and filtering the set of users based on various criteria, such as their test scores. A potential mentor may be a knowledgeable person who is a peer of the user (e.g., rather than someone who is involved in the creation of the training content). To identify potential mentors, after identifying users that have passed the test, a tree search algorithm may be used to search an organization chart (e.g., the organization chart may be retrieved from an Active Directory or a similar database), to locate a mentor who is relatively close to the user (e.g., in the organization chart, in terms of physical location, or both).

Thus, a software application may be written with a standard mode and a tutorial mode. In the standard mode, the user interface of the software application may be coupled to the standard functionality of the software application to enable a user to use the UI to perform the normal functions of the software application to a computing system that is being used by multiple users. In the tutorial mode, the user interface of the software application may be coupled to the tutorial functionality of the software application to enable a user to use the UI to perform the functions of the software application to mock (e.g., simulated) data. In contrast, conventional training software may be separate and distinct from the software application itself and may not provide an exact simulation of the software application.

In the tutorial mode, the user may be provided with one or more tutorials explaining how to use the software application to perform various functions. After a tutorial has been presented, the software application may automatically (e.g., without human interaction) administer a corresponding test to determine the user's comprehension of the information provided in the tutorial. If the user receives a passing grade on the test, the software application may automatically provide a next tutorial followed by a next test. If the user fails to receive a passing grade on the test, the software application may send a request to a server to identify potential mentors for test. The server may identify a set of users that have passed the test based on a database used to store test results associated with users who have passed the tests. The set of users may be filtered using various criteria (e.g., a score received on the test, a proximity of a successful test taker to the user, a department of the successful test taker, etc.) to identify a subset of the set of users, e.g., a set of potential mentors. The server may identify data associated with the set of potential mentors, such as their names, contact information, department, location, etc. The software application may display the data received from the server and automatically initiate a communications session (e.g., voice call, video call, instant message session, etc.) with at least one of the potential mentors or enable the user to manually initiate a communications session with at least one of the potential mentors.

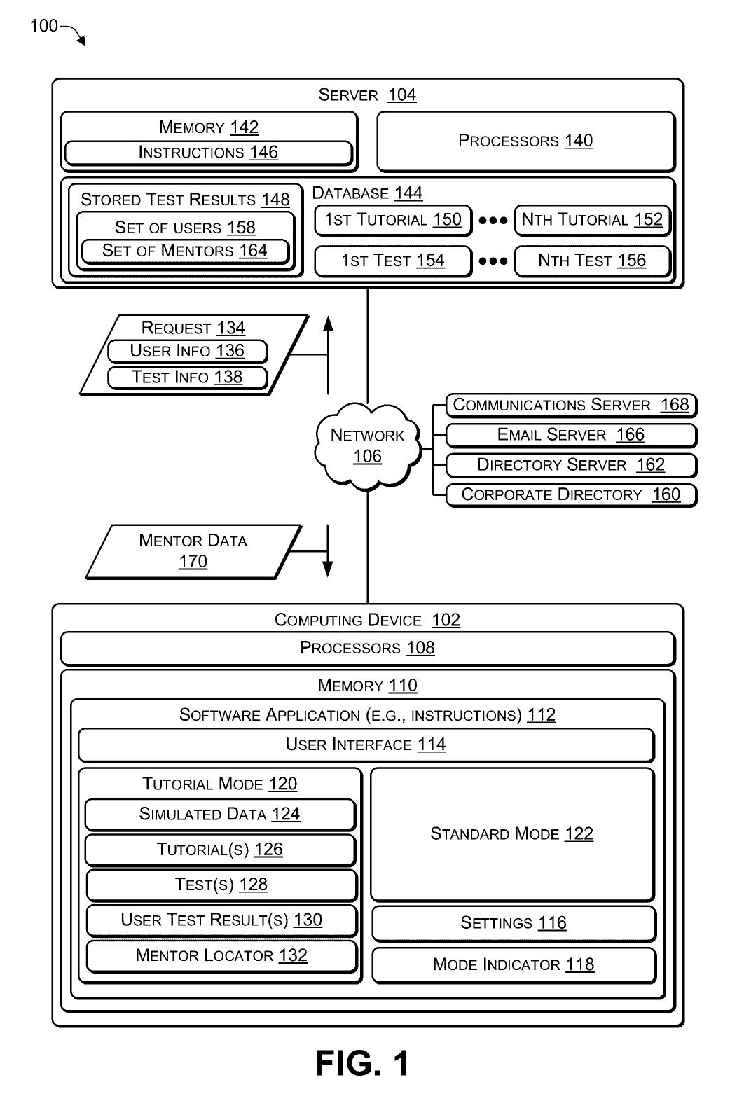

FIG. 1 is a block diagram illustrating an architecture 100 to identify one or more potential mentors according to some embodiments. The architecture 100 includes a computing device 102 coupled to a server 104 via a network 106. The network 106 may include a variety of communication technologies and communication standards, such as, for example, Ethernet, DOCSIS, DSL, WiFi, Bluetooth, CDMA, GSM, etc. Of course, additional computing devices may be connected to the network 106.

The computing device 102 may be a desktop computer, a laptop computer, a tablet computer, a wireless phone, etc. The computing device 102 may include one or more processors 108 and a memory 110 (e.g., computer-readable storage media, such as random access memory (RAM), read only memory (ROM), disk drives, etc.) to store instructions that are executable by the one or more processors 108 and to store data. For example, the memory 110 may be used to store a software application 112 that includes instructions executable by the processors 108. The software application may include a user interface (UI) 114, settings 116, a mode indicator 118, a tutorial mode 120, and a standard mode 122. The user interface 114 may be coupled to the standard mode 122 portion of the software application 112 to provide standard functionality, e.g., to use the UI 114 to make changes to a computing system (e.g., via the network 106) that is being used by multiple users. The user interface 114 may be decoupled from the standard mode 122 portion of the software application 112 and coupled to the tutorial mode 120 portion of the software application 112 to provide tutorial functionality, e.g., to use the UI 114 to perform functions to simulated data 124 (e.g., mock data). The settings 116 may include various settings associated with the software application 112. For example, one of the settings 116 may indicate whether to automatically initiate a communications session with a potential mentor. The mode indicator 118 may indicate whether the software application 112 is coupled to the tutorial mode 120 portion or the standard mode 122 portion of the software application 112.

The tutorial mode 120 may enable the user to use the UI 114 to perform functions to the simulated data 124. The tutorial mode 120 may provide one or more tutorials 126 to a user. The tutorials 126 may include one or more of audio tutorials, video tutorials, text-based tutorials, tutorials that provide a graphical overlay to a portion of the user interface 114 that is being displayed, etc. The one or more tutorials 126 may have one or more corresponding tests 128. For example, after a tutorial from the tutorials 126 has been presented to a user, the software application 112 may administer a test from the tests 128 to determine whether the user has correctly understood the information presented by the tutorial. After administering each of the tests 128, the software application 112 may determine each of user test results 130. For example, after presenting a first tutorial, the software application 112 may administer a first test and determine first user test results associated with the first test, after presenting a second tutorial, the software application 112 may administer a second test and determine second user test results associated with the second test, and so on. If the software application 112 determines that particular test results of the user test results 130 does not satisfy a threshold, the software application 112 may determine that the user has failed the corresponding test and use a mentor locator 132 application to identify one or more potential mentors. For example, the user may pass the test when the user obtains a score of at least 50% correct, at least 51% correct, at least 60% correct, at least 75% correct etc. In some cases, each test may have a different threshold. For example, tests associated with non-critical UI functions may have a lower passing threshold (e.g., at least 51% correct) compared to the tests associated with critical UI functions (e.g., a threshold of at least 60% correct).

The mentor locator 132 may send a request 134 to the server 104 requesting the server 104 to identify one or more potential mentors. The request 134 may include user information 136 identifying the user and test information 138 identifying the test that the user failed. For example, the user information 136 may include information to uniquely identify the user within a company, e.g., the user's name (e.g., John W. Smith”), the user's employee identifier (e.g. “1577280”), the user's logon username for the computing system (e.g., john.w.smith), email address (e.g., john.w.smith@mycompany.com), other information that uniquely identifies the user, or any combination thereof. The test information 138 may identify the test that the user failed (e.g., module 1, test number 2), the most recently taken tutorial (e.g., tutorial number 3), a name of the software application (e.g., Change Auditor v2.0), a name of the functionality being taught by the tutorial (e.g., generating an audit trail for accesses to a database), other tutorial-related information, or any combination thereof.

The server 104 may include one or more processors 140, memory 142 (e.g., computer-readable storage media, such as ROM, RAM, disk drives, etc.), and a database 144. The memory 142 may store instructions 146 that are executable by the processors 140 to perform the various functions described herein.

The database 144 may include stored test results 148, a first tutorial 150 to an Nth tutorial 152, and corresponding to the N tutorials (N>0), a first test 154 to an Nth test 156. The stored test results 148 may include test results from tests administered to multiple users and may include test results associated with multiple software applications (e.g., in addition to the software application 112). The computing device 102 may dynamically (e.g., “on-demand”) download one or more of the tutorials 150 to 152, one or more of the tests 154 to 156, or both from the server 104. For example, after the user selects a particular tutorial, the computing device 102 may download the corresponding tutorial from the tutorials 150 to 152 and the corresponding test 154 to 156. A training specialist may periodically update one or more of the tutorials 150 to 152 or the tests 154 to 156 to reflect changes to the software application 112, to improve the learning experience, or to improve how the user is tested. For example, if a new version of the software application 112 is released, one or more of the tutorials 150 to 152 or the tests 154 to 156 may be updated (e.g., modified or replaced) to reflect the changes to the software application 112. As another example, if more than a threshold percentage of people that take a particular tutorial are failing the corresponding test, the particular tutorial may be updated (e.g., to provide information that is more easily understood) or the corresponding test may be updated (e.g., to make the questions more easily understood).

In response to receiving the request 134 to identify potential mentors, the server 104 may identify, based on the stored test results 148, a set of users 158 that have passed the test identified by the test information 138. In some cases, the server 104 may determine the set of users 158 by identifying users that have scored at least a threshold amount (e.g., 75%) on the test. Based on the set of users 158, a tree search algorithm may be used to search a corporate directory 160 to locate a mentor who is relatively close to the user (e.g., close in terms of being in a same or nearby department, in terms of a physical location, or both). The corporate directory 160 may include an organization chart retrieved from a server, such as a directory server 152 (e.g., an Active Directory or similar database). The set of users 158 may be correlated with the information in the corporate directory to determine a physical (e.g., geographic) location, a department number, a manager, and other corporate information associated with each user of the set of users 158. The set of users 158 with the correlated information may be filtered based on one or more criteria to identify a set of mentors 164. If less than a threshold number of potential mentors are identified after filtering, the process of (i) modifying the criteria and (ii) filtering the set of users 158 using the modified criteria may be repeated until a minimum number of potential mentors have been identified. For example, the set of users 158 (with the correlated information) may be filtered based on a building and a floor of the building in which the user is located to identify potential mentors that are geographically located in close proximity to the user. If the filtered results include less than a threshold number of users (e.g., less than five), then the criteria may be modified. For example, the floor of the building may be removed from the criteria and the set of users 158 filtered again. If less than the threshold number of users are identified, then the criteria may be modified, e.g., to use (i) a city in which the building is located, (ii) a state in which the building is located, or (iii) a country in which the building is located, and the set of users 158 filtered using the modified criteria. If, after a threshold number of iterations of modifying the criteria and filtering the set of users 158, less than the threshold number of users are identified, then the identified users may be selected as the set of mentors 164. When at least the threshold number of users have been identified, the identified users may be selected as the set of mentors 164.

In some cases, the server 104 may identify expert users for inclusion in the set of mentors 164. An expert user may be someone who frequently responds to questions regarding one or more topics associated with the software application 112. For example, after identifying the set of users 158 that have passed the test taken by the user, the server 104 may analyze communications (e.g., archived emails, archived instant messaging sessions, archived video conference sessions, etc.) to determine whether each user of the set of users 158 frequently answers questions associated with using the software application 112. To illustrate, analyzing archived emails to and/or from a particular user (e.g., that has passed the test) may indicate that the particular user frequently answers questions related to the software application and may, therefore, be considered an “expert user” of the software application. For example, a machine learning algorithm, such as a classifier (e.g., support vector machine or other type of classifier), may be used to analyze communications associated with each user in the set of users 158 to identify expert users.

After determining the set of mentors 164 by filtering the set of users 158 that passed the test based on one or more criteria, the server 104 may determine information associated with the set of mentors 164. For example, the server 104 may use the corporate directory 160 to determine a department number of each mentor, a geographic location (e.g., country, state, city, building, floor, etc.) of each mentor, a phone number of each mentor, etc. The server 104 may use an email server 166 to determine an email address associated with each mentor in the set of mentors 164. The server 104 may use a communications server 168 to determine an instant messaging address associated with each mentor in the set of mentors 164. The server 104 may use the communications server 168 to determine a video conferencing address associated with each mentor in the set of mentors 164. The server 104 may send mentor data 170 to the computing device 102. The mentor data 170 may include the set of mentors 164 and their associated information, such as, for example, a location, a department, a manager, a phone number, an email address, an instant messaging address, a video conferencing address, and other information associated with each mentor.

The mentor locator 132 may receive the mentor data 170 from the server 104 and display the mentor data 170 on a display device. The computing device 102 may automatically (e.g., without human interaction) initiate a communications session, such as a phone call (e.g., VoIP), a video conference call (e.g., Skype or other SIP-based video call), or an instant messaging session with one (or more) of the mentors. The computing device 102 may enable the user to manually initiate a communications session with one (or more) of the mentors.

Thus, a user who desires to learn how to use a software application may place the software application in a tutorial mode in which the user interface of the software application is decoupled from the standard mode functionality and coupled to a tutorial mode functionality in which the user is provided tutorials instructing the user on how to use the software application. The tutorials may be presented using audio, video, text, graphical overlays, or any combination thereof. After one or more tutorials, the software application may administer a test to determine the user's comprehension of the information presented by the one or more tutorials. If the software application determines that, based on the test results, the user has failed to understand the information, the software application may send a request to the server 104 to identify a set of mentors that are familiar with the topic being tested and that are located geographically or corporately (e.g., in a same or nearby department) close to the user. The server 104 may identify a set of mentors, determine contact information for each mentor, and send the mentor data to the software application. The software application may receive and display the mentor data and automatically, or in response to user input, initiate a communications session with one or more mentors. During the communications session, the user may ask the mentor(s) questions to clarify the user's understanding of the topic and then retake the test or move on to a next tutorial and a next test.

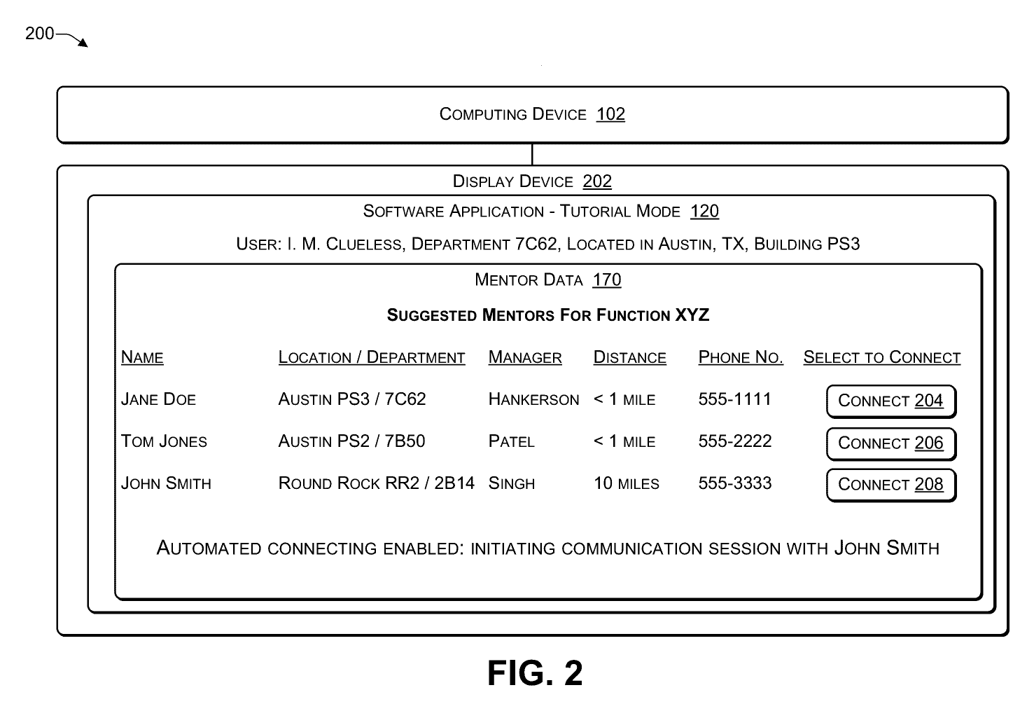

FIG. 2 is a block diagram illustrating an architecture 200 to display mentor data according to some embodiments. For example, the computing device 102 may display the mentor data 164 on a display device 202 when using the tutorial mode 120 portion of the software application. The mentor data 164 may include information associated with each mentor, such as, for example, the name of each mentor, a location of each mentor, a department number of each mentor, a manager of each mentor, a distance from the user, contact information associated with each mentor, etc. In FIG. 2, a phone number is used as an example of the contact information. However, in some cases, additional contact information, such as an email address, a video conferencing (e.g., Skype®) identifier, an instant messaging identifier, or other contact information may be displayed instead of or in addition to the phone number. In the tutorial mode, after receiving the mentor data 170, the computing device 102 may automatically (e.g., without human interaction) initiate a communication session (e.g., phone call, video conference, instant messaging session or the like) with a first person in the set of suggested mentors. If the first person does not respond, the computing device 102 may automatically move on to the next person in the set of suggested mentors until a communication session is established with one of the suggested mentors or until an attempt has been made to contact each of the mentors identified by the mentor data 170.

Of course, the user may manually override the automating calling feature and manually initiate a communications session with one of the suggested mentors. For example, the user may select connect 204 to initiate a communications session with mentor Jane Doe, the user may select connect 206 to initiate a communications session with mentor Tom Jones, or the user may select connect 208 to initiate a communications session with mentor John Smith.

Thus, the computing device 102 may receive the mentor data 170 from the server 104 and display at least a portion of the mentor data 170 on the display device 202. If automated connecting is enabled, the computing device 102 may automatically attempt to initiate a communication session with one of the mentors using the mentor data 170. If automated connecting is disabled, the user may manually attempt to initiate a communication session with one of the mentors.

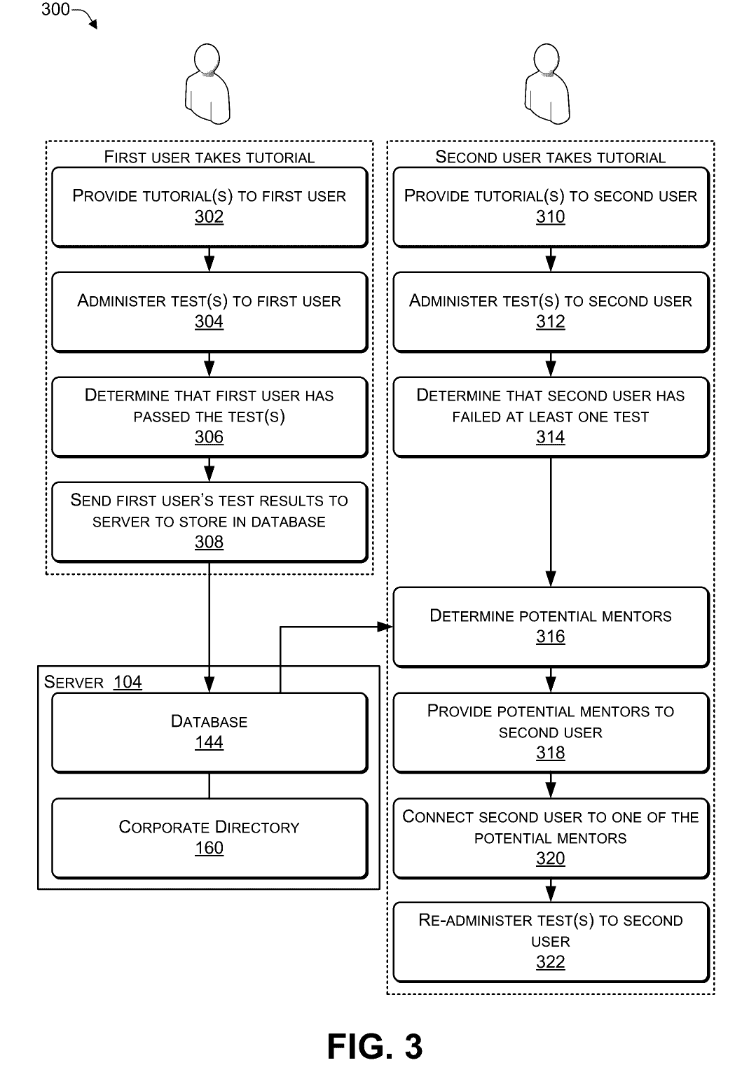

In the flow diagrams of FIGS. 3, 4, 5, 6, and 7, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 300, 400, 500, 600, and 700 are described with reference to FIGS. 1 and 2, as described above, although other models, frameworks, systems and environments may be used to implement these processes.

FIG. 3 is a flowchart of a process that includes determining a potential mentor for a test based on a database of test results according to some embodiments. The process may be performed by the computing device 102 of FIGS. 1 and 2, the server 104 of FIG. 1, or a combination of both.

At 302, one or more tutorials may be provided to a first user. At 304, one or more tests (e.g., corresponding to the one or more tutorials) may be administered to the first user. For example, in FIG. 1, the tutorials 126 may be presented to a user and the tests 128 presented to the user.

At 306, a determination may be made that the first user has passed the one or more tests. At 308, the user's test results may be sent to a server where the test results may be stored in a database. For example, in FIG. 1, after the user passes one or more of the tests 128, the test results may be stored in the database 144 (e.g., in the stored test results 148).

At 310, one or more tutorials may be provided to a second user. At 312, one or more tests may be administered to the second user. At 314, a determination may be made that the second user has failed at least one test. At 316, one or more potential mentors may be identified from the database 144 and their contact information may be determined using the corporate directory 160. At 318, the potential mentors may be provided to the second user. At 320, a communication session between the second user and one of the potential mentors may be established automatically or in response to a manual selection by the second user. At 322, the test(s) may be re-administered to the second user. For example, in FIG. 1, when executing the tutorial mode 120 portion of the software application 112, the second user may be presented with the one or more tutorials 126 after which the software application 112 may administer one or more tests 128. If the user test results 130 indicate that the second user has failed at least one of the tests, the mentor locator 132 may send the request 134 to the server 104 requesting a set of one or more mentors for a particular test (identified by the test info 138) for the second user (identified by the user info 136). The server 104 may search the database 144 for a set of users that have passed the test identified by the test info 138 and then identify potential mentors from the set of users by identifying users that are, by geography or by organizational department, in close proximity to the second user. The server 104 may identify contact information (e.g., email address, phone number, video chat address, etc.) associated with each potential mentor and then send the mentor data 170 to the computing device 102. As illustrated in FIG. 2, the computing device 102 may display the mentor data 170 and may connect the second user automatically (or in response to the second user selecting a particular mentor) with a mentor. After the communication session with the mentor has ended, the software application 112 may re-administer one or more of the tests 128 to determine if the second user has understood the information provided by the mentor.

Thus, after a first user is presented with a tutorial and then administered a test, if the user passes the test, the test results may be stored in a database. When a second user takes the test but does not pass the test, the second user may be provided with the contact information associated with potential mentors, including the first user, who have previously passed the test. The software application presenting the tutorial and administering the test may establish a communication session between the second user with the first user. The communication session may be established automatically or in response to the second user selecting a user interface element to establish the communication session.

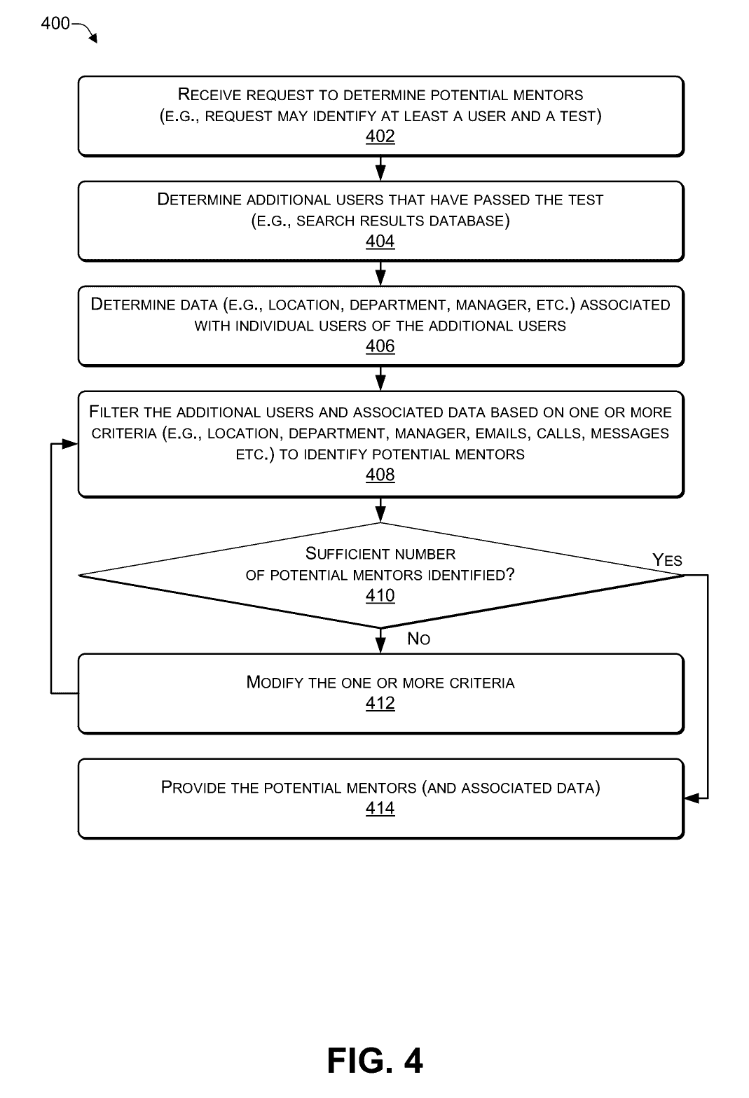

FIG. 4 is a flowchart of a process that includes determining a sufficient number of potential mentors according to some embodiments. The process may be performed by the server 104 of FIG. 1.

At 402, the server may receive a request (e.g., from a computing device) to determine potential mentors. The request may identify at least a test and a user. At 404, additional users that have passed the test may be determined. At 406, data associated with individual users of the additional users may be identified. At 408, the additional users and the associated data may be filtered based on one or more criteria (e.g., location, department, manager, emails, calls, messages, etc.) to identify potential mentors. For example, in FIG. 1, when executing the tutorial mode 120 portion of the software application 112, a user may be presented with the one or more tutorials 126 after which the software application 112 may administer one or more tests 128. If the user test results 130 indicate that the user has failed at least one of the tests, the mentor locator 132 may send the request 134 to the server 104 requesting a set of one or more mentors for a particular test (identified by the test info 138) for the user (identified by the user info 136). The server 104 may search the database 144 for a set of users that have passed the test identified by the test info 138 and then identify potential mentors from the set of users by identifying additional users that are, by geography or by organization (e.g., same manager), in close proximity to the user.

At 410, a determination may be made whether a sufficient number of mentors have been identified. If a determination is made, at 410, that an insufficient number of potential mentors have been identified, then the one or more criteria may be modified, at 412, and the process may proceed to 408, where the additional users and the associated data are filtered using the modified criteria. If a determination is made, at 410, that a sufficient number of potential mentors have been identified, then the potential mentors and the associated data may be provided (e.g., to the computing device that sent the request), at 414. For example, in FIG. 1, the server 104 may filter the set of users 158 based on one or more criteria to determine the set of mentors 164. The server 104 may repeatedly modify the criteria until a threshold number of mentors have been identified. The server 104 may determine data associated with the mentors, such as geographic location (e.g., city, building, floor etc.), contact information, department number, manager, etc. The server 104 may send the mentor data 170 that includes the names of the potential mentors and their associated data to the computing device 102.

Thus, a software application may present a tutorial to a user and then administer a test to determine the user's comprehension of the material presented in the tutorial. If the user fails the test, the software application may request a set of mentors from a server. For example, the software application may provide information identifying the user and information identifying the test to the server. The server may search a database to identify additional users that have passed the test and determine data associated with the additional users, such as where each of the additional users are located, their manager's name, etc. The server may filter the additional users based on various criteria to identify a set of potential mentors. For example, the server may filter the additional users to identify potential mentors that are located within a threshold distance (e.g., geographically in terms of location or organizationally in terms of department) from the user. If too many potential mentors are identified or an insufficient number of mentors are identified, the criteria may be modified and the additional users and their associated data re-filtered.

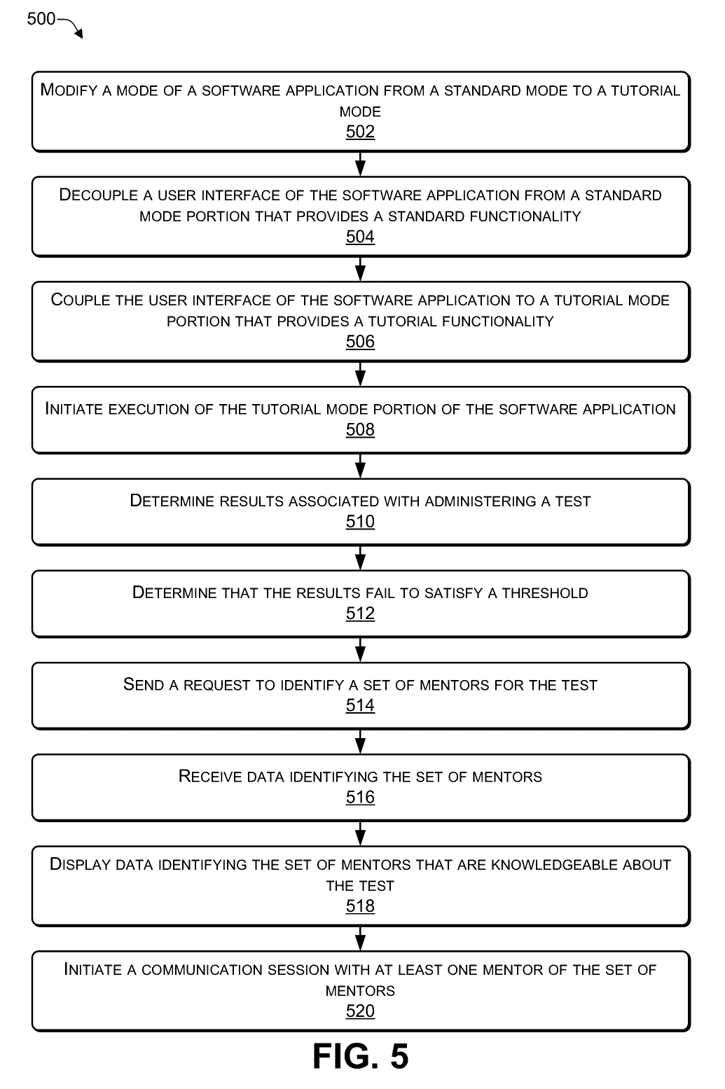

FIG. 5 is a flowchart of a process that includes modifying a mode of a software application from a standard mode to a tutorial mode according to some embodiments. The process may be performed by the computing device 102 of FIG. 1.

At 502, a mode of a software application may be modified from a standard mode to a tutorial mode. At 504, a UI of the software application may be decoupled from a standard mode portion of the software application that provides a standard functionality. At 506, the UI of the software application may be coupled to a tutorial mode portion of the software application that provides a tutorial functionality. At 508, execution of the tutorial mode portion of the software application may be initiated. For example, in FIG. 1, a user may provide a selection to instruct the software application 112 to enter a tutorial mode. In response, the software application 112 may decouple the UI 114 from the standard mode 122 portion of the software application 112, couple the UI 114 to the tutorial mode 120 portion, and initiate execution of the instructions of the tutorial mode 120.

At 510, results associated with administering a test (e.g., after a tutorial has been presented) may be determined. At 512, a determination may be made that test results for the test fail to satisfy a threshold. At 514, a request may be sent (e.g., to a server) to identify a set of mentors for the test. At 516, data identifying the set of mentors may be received (e.g., from a server). At 518, the data identifying the set of mentors that are knowledgeable about the test may be displayed. At 520, a communication session with at least one mentor of the set of mentors may be initiated, e.g., either automatically or in response to a user selection. For example, in FIG. 1, the software application 112 may present one of the tutorials 126, administer one of the corresponding tests 128, and determine the user test results 130. If the user test results 130 are below a threshold, indicating that the user has failed one of the tests 128, then the mentor locator 132 may send the request 134 requesting the set of mentors 164 to the server 104. The server 104 may determine the set of mentors 164 and send the mentor data 170. The software application 112 may initiate, either automatically or in response to a user selection, a communications session with at least one mentor of the set of mentors 164.

Thus, a software application may present a tutorial to a user and then administer a test to determine the user's comprehension of the material presented in the tutorial. If the user fails the test, the software application may request a set of mentors from a server. For example, the software application may provide information identifying the user and information identifying the test to the server. The server may search a database to identify additional users that have passed the test and determine data associated with the additional users, such as where each of the additional users is located, their manager's name, etc. The server may filter the additional users based on various criteria to identify a set of potential mentors. The server may send the set of mentors to the software application. The software application may display the set of mentors and initiate a communications session, either automatically or in response to a user selection, with at least one mentor of the set of mentors.

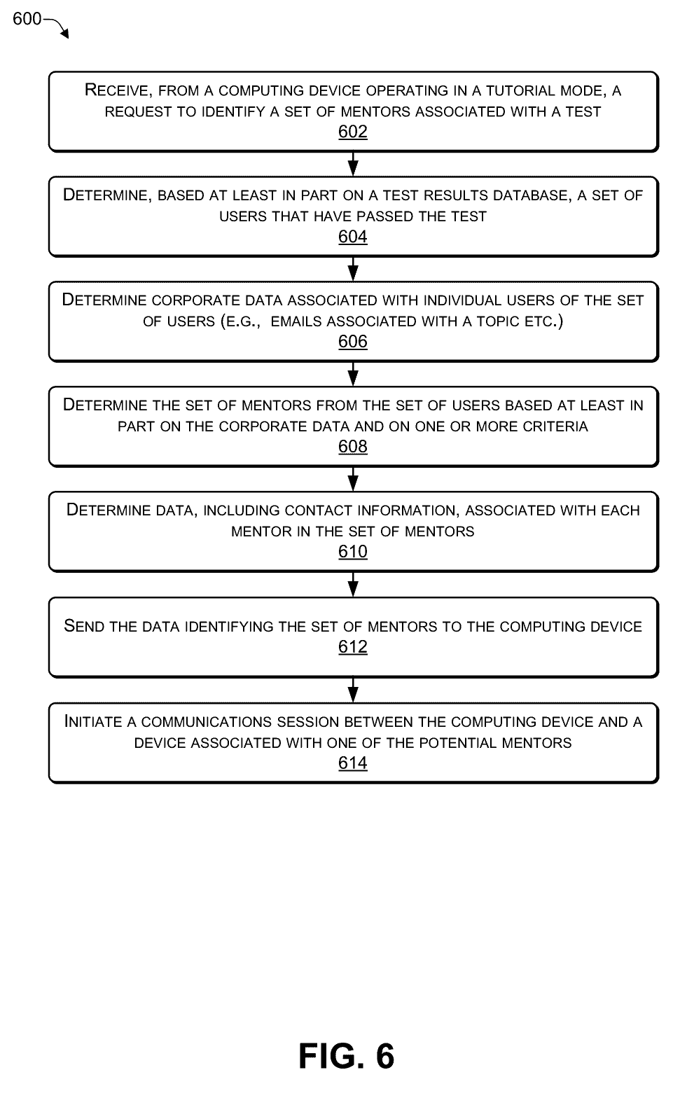

FIG. 6 is a flowchart of a process that includes determining a set of mentors according to some embodiments. The process may be performed by the server 104 of FIG. 1.

At 602, a server may receive a request, from a computing device operating in a tutorial mode, to identify a set of mentors associated with a test. At 604, the server may determine a set of users that have passed the test based at least in part on a test results database. At 606, the server may determine corporate data (e.g., a manager, a department, location information, such as a city, a building, a floor, etc.) associated with individual users of the set of users. At 608, the server may identify the set of mentors from the set of users based at least in part on the corporate data and on one or more criteria. For example, in FIG. 1, when executing the tutorial mode 120 portion of the software application 112, a user may be presented with the one or more tutorials 126 after which the software application 112 may administer one or more tests 128. If the user test results 130 indicate that the user has failed at least one of the tests, the mentor locator 132 may send the request 134 to the server 104 requesting a set of one or more mentors for a particular test (identified by the test info 138) for the user (identified by the user info 136). The server 104 may search the database 144 for a set of users that have passed the test identified by the test info 138 and then identify (e.g., filter) potential mentors from the set of users by identifying those users in the set of users that are, by geography or by organization (e.g., same manager), in close proximity to the user. The server 104 may determine how many communications (e.g., emails, instant messaging sessions, etc.) are related to the topic being tested (e.g., based on the test info) to identify users who are considered experts in the topic by their peers. For example, an analysis of a particular user's communications may indicate that the particular user answers two or more questions (e.g., sent by other users) that are related to a particular topic every week and is, therefore, considered to be an expert on the particular topic by the particular user's peers. The server 104 may select the particular user as a mentor based on analyzing the data gathered from the communications server 168 and/or the email server.

At 610, the server may determine data, including contact information, associated with individual mentors of the set of mentors. At 612, the server may send, to the computing device, the data identifying the set of mentors. At 614, a communications session between the computing device and a device associated with one of the potential mentors may be initiated. For example, in FIG. 1, after identifying one or mentors, the server 104 may determine data associated with each mentor, such as their contact information, and send the mentor data 170 to the computing device 102. The server 104 or the computing device 102 may initiate a communications session between a communications device associated with the user and a communications device associated one of the mentors. The communications session may be setup automatically or in response to a user selecting data associated with one of the mentors that is being displayed on a user interface (e.g., as illustrated in FIG. 2).

Thus, a software application may administer a test to determine a user's comprehension of material presented in a tutorial. If the user fails the test, the software application may request a set of mentors from a server. For example, the software application may provide information identifying the user and information identifying the test to the server. The server may search a database to identify additional users that have passed the test and determine data associated with the additional users, such as where each of the additional users is located, their manager's name, etc. The server may filter the additional users based on various criteria to identify a set of potential mentors. The server may send the set of mentors to the software application. The software application may display the set of mentors and initiate a communications session, either automatically or in response to a user selection, with at least one mentor of the set of mentors.

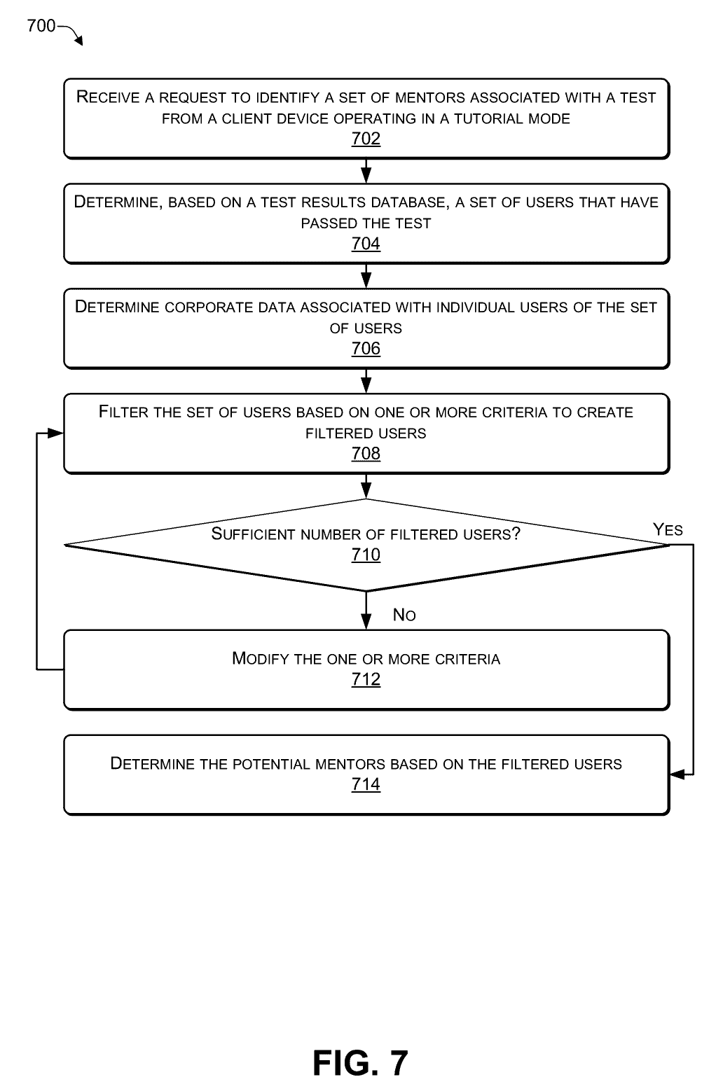

FIG. 7 is a flowchart of a process that includes filtering a set of users based on one or more criteria according to some embodiments. The process may be performed by the server 104 of FIG. 1.

At 702, a server may receive request to identify a set of mentors associated with a test may be received from a client device operating in a tutorial mode. At 704, the server may identify a set of users that have passed the test based on a test results database. At 706, the server may determine corporate data associated with individual users of the set of users. At 708, the set of users may be filtered using one or more criteria to create filtered users. At 710, a determination may be made whether a number of the filtered users satisfies a threshold. If a determination is made, at 710, that there are an insufficient number of filtered users, the criteria made be modified, at 712, and the set of users may be filtered using the modified criteria, at 708. The process of modifying the criteria and filtering the users may be repeated until there are a sufficient number of filtered users (e.g., until the number of filtered users satisfies the threshold). After a determination is made, at 710, that there are a sufficient number of filtered users (e.g., the number of filtered users satisfies the threshold), then the potential mentors are determined based on the filtered users. For example, in FIG. 1, the server 104 may filter the set of users 158 based on one or more criteria (e.g., manager, location, etc.) to determine the set of mentors 164. For example, the criteria may be used to identify mentors that are in a same location or under a same manager as the user. The server 104 may repeatedly modify the criteria until a threshold number of mentors have been identified. The server 104 may determine data associated with the mentors, such as geographic location (e.g., city, building, floor etc.), contact information, department number, manager, etc. The server 104 may send the mentor data 170 that includes the names of the potential mentors and their associated data to the computing device 102.

Thus, a software application may present a tutorial to a user and then administer a test to determine the user's comprehension of the material presented in the tutorial. If the user fails the test, the software application may request a set of mentors from a server. For example, the software application may provide information identifying the user and information identifying the test to the server. The server may search a database to identify additional users that have passed the test and determine data associated with the additional users, such as where each of the additional users are located, their manager's name, etc. The server may filter the additional users based on various criteria to identify a set of potential mentors. For example, the server may filter the additional users to identify potential mentors that are located within a threshold distance (e.g., geographically in terms of location or organizationally in terms of department) from the user. If too many potential mentors are identified or an insufficient number of mentors are identified, the criteria may be modified and the additional users and their associated data re-filtered.

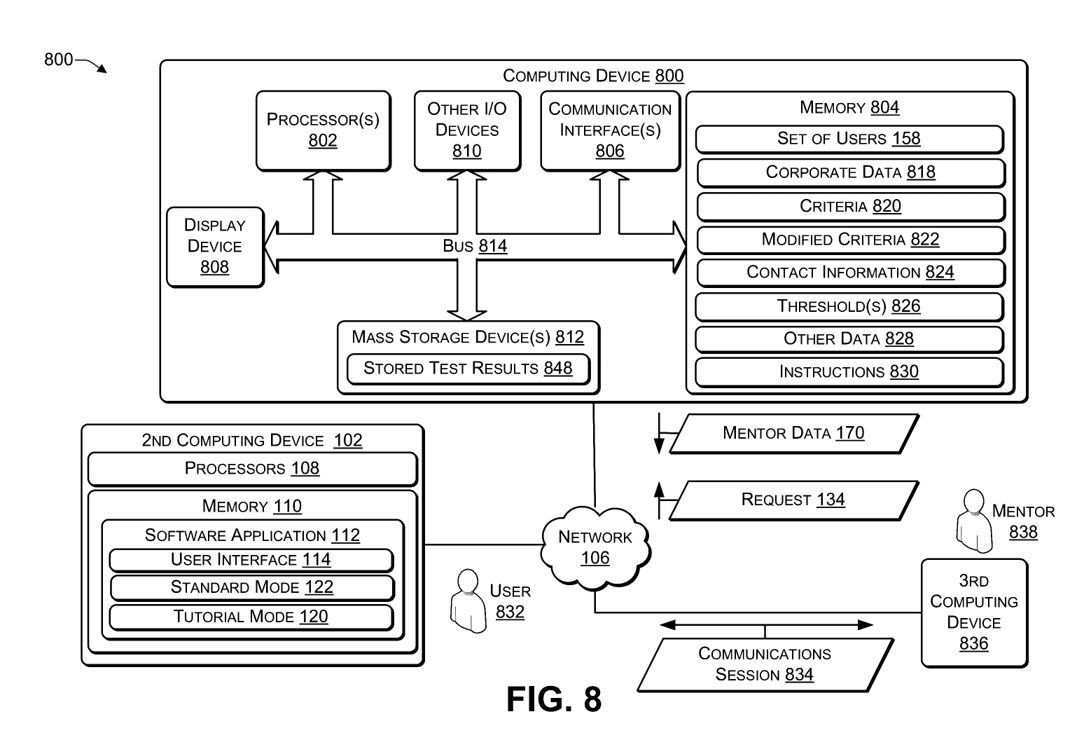

FIG. 8 illustrates an example configuration of a computing device 800 and environment that can be used to implement the modules and functions described herein. For example, the computing device 800 may be used to implement the computing device 102 or the server 104 of FIGS. 1 and 2. The computing device 800 may include at least one processor 802, a memory 804, communication interfaces 806, a display device 808, other input/output (I/O) devices 810, and one or more mass storage devices 812, configured to communicate with each other, such as via a system bus 814 or other suitable connection.

The processor 802 may be a single processing unit or a number of processing units, all of which may include single or multiple computing units or multiple cores. The processor 802 can be implemented as one or more microprocessors, microcomputers, microcontrollers, digital signal processors, central processing units, state machines, logic circuitries, and/or any devices that manipulate signals based on operational instructions. Among other capabilities, the processor 802 can be configured to fetch and execute computer-readable instructions stored in the memory 804, mass storage devices 812, or other computer-readable media.

Memory 804 and mass storage devices 812 are examples of computer storage media for storing instructions which are executed by the processor 802 to perform the various functions described above. For example, memory 804 may generally include both volatile memory and non-volatile memory (e.g., RAM, ROM, or the like). Further, mass storage devices 812 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 804 and mass storage devices 812 may be collectively referred to as memory or computer storage media herein, and may be a non-transitory media capable of storing computer-readable, processor-executable program instructions as computer program code that can be executed by the processor 802 as a particular machine configured for carrying out the operations and functions described in the implementations herein.

The computer storage media, such as memory 804 and mass storage devices 812, may be used to store software and data. For example, the data may include the set of users 158 (e.g., users that have passed a particular test), corporate data 818 (e.g., a manager, a department, location information, such as a city, a building, a floor, etc.), criteria 820 (e.g., geographic location, distance from the user, manager, number of questions related to the topic that are answered, etc.), modified criteria 822, contact information 824 (e.g., email address, phone number, instant messaging address, video conferencing address, etc.), thresholds 826 (e.g., number of mentors to identify, number of communications regarding a topic that a user answers, number of correct responses to a test that results in a user passing the test), and other data 828. The software may include instructions 830 that are executable by the processors 820 to perform the various functions described herein.

The computing device 800 may also include one or more communication interfaces 806 for exchanging data with the second computing device 102. The communication interfaces 806 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet and the like. Communication interfaces 806 can also provide communication with external storage (not shown), such as in a storage array, network attached storage, storage area network, or the like.

A display device 808, such as a monitor may be included in some implementations for displaying information and images to users. Other I/O devices 810 may be devices that receive various inputs from a user and provide various outputs to the user, and may include a keyboard, a remote controller, a mouse, a printer, audio input/output devices, and so forth.

A user 832 may use the second computing device 102 to place the software application 112 in the tutorial mode 120 in which the user interface 114 is decoupled from the standard mode 122 and coupled to the tutorial mode. The software application 112 may present a tutorial on a topic to the user 832. The software application 112 may administer a test on the topic to the user 832. If the software application 112 determines that the test results indicate that the user 832 has not understood the information presented in the test, the software application 112 may send the request 134 to the computing device 800 (e.g., the server 104 of FIG. 1) requesting one or more mentors for the user 832. The computing device 800 may identify the set of users 158 that have passed the test, determine the corporate data 818 associated with each of the users in the set of users, filter the set of users 158 based on the criteria 820 to identify a set of mentors, and determine data (e.g., contact information) associated with the mentors to create the mentor data 170. The second computing device 102 may receive the mentor data 170 from the computing device 800 (e.g., the server 104) and initiate a communications session 834 between a device (e.g., the second computing device 102) of the user 832 with a third computing device 836 that is associated with a mentor 838.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various embodiments of the method and apparatus of the present invention have been illustrated herein in the Drawings and described in the Detailed Description, it will be understood that the invention is not limited to the embodiments disclosed, but is capable of numerous rearrangements, modifications and substitutions without departing from the scope of the present disclosure.

What is claimed is:

1. A computer-implemented method, comprising:
modifying, by one or more processors of a computing device, a mode of a software application from a standard mode to a tutorial mode;
decoupling, by the one or more processors, a user interface of the software application from a standard mode portion of the software application that provides a standard functionality;
coupling, by the one or more processors, the user interface of the software application to a tutorial mode portion of the software application that provides a tutorial functionality;
administering, by the one or more processors, a first test associated with a first tutorial;
determining, by the one or more processors, first results associated with administering the first test;
determining, by the one or more processors, that the first results fail to satisfy a first threshold; and
displaying, by the one or more processors, data identifying a first set of mentors that are knowledgeable about the first test, wherein the data includes contact information associated with individual mentors of the first set of mentors.

2. The computer-implemented method of claim 1, further comprising:
initiating, in response to determining the first of mentors, a communication session with a communication device associated with a mentor of the first set of mentors.

3. The computer-implemented method of claim 1, wherein before displaying the first set of mentors associated with the first test the computer-implemented method further comprises:
sending a request, from the computing device to a server, to identify the first set of mentors for the first test; and
receiving, by the computing device, the data identifying the first set of mentors from the server.

4. The computer-implemented method of claim 1, further comprising:
administering a second test associated with a second tutorial;
determining second results associated with administering the second test;
determining that the second results fail to satisfy a second threshold; and
displaying second data identifying a second set of mentors associated with the second test, wherein the second set of mentors includes at least one mentor that is not included in the first set of mentors.

5. The computer-implemented method of claim 4, further comprising:
sending a second request, from the computing device to a server, to identify the second set of mentors for the second test; and
receiving, by the computing device, the second data identifying the second set of mentors from the server.

6. The computer-implemented method of claim 1, wherein the first set of mentors are identified from a database storing test results associated with administering a plurality of tests associated with the software application, wherein the plurality of tests include the first test.

7. The computer-implemented method of claim 1, wherein displaying the first set of mentors associated with the first test comprises:
displaying contact information, including at least one of a phone number, an email address, or a video conferencing address, associated with individual mentors of the first set of mentors.

8. The computer-implemented method of claim 1, wherein at least one mentor of the first set of mentors is located within:
a predetermined geographical distance from a user to which the first test is being administered, or
a same department in a company as the user.

9. One or more non-transitory computer-readable media comprising instructions that are executable by one or more processors to perform operations comprising:
modifying a mode of a software application from a standard mode to a tutorial mode;
decoupling a user interface of the software application from a standard mode portion of the software application that provides a standard functionality;
coupling the user interface of the software application to a tutorial mode portion of the software application that provides a tutorial functionality;
administering a first test associated with a first tutorial;
determining first results associated with administering the first test;
determining that the first results fail to satisfy a first threshold; and
displaying first data identifying a first set of mentors associated with the first test.

10. The one or more non-transitory computer-readable media of claim 9, the operations further comprising:
sending a request to a server to identify the first set of mentors for the first test; and
receiving the first data identifying the first set of mentors from the server.

11. The one or more non-transitory computer-readable media of claim 9, the operations further comprising:
administering a second test associated with a second tutorial;
determining second results associated with administering the second test;
determining that the second results fail to satisfy a second threshold;
sending a second request to a server identify a second set of mentors associated with the second test; and
displaying second data identifying the second set of mentors associated with the second test, wherein the second set of mentors includes at least one mentor that is not included in the first set of mentors.

12. The one or more non-transitory computer-readable media of claim 9, wherein the first set of mentors are identified from a database storing test results associated with administering a plurality of tests associated with the software application, wherein the plurality of tests include the first test.

13. The one or more non-transitory computer-readable media of claim 9, wherein at least one mentor of the first set of mentors is located within:
a predetermined geographical distance from a user to which the first test is being administered, or
a same department in a company as the user.

14. A server, comprising:
one or more processors; and
one or more non-transitory computer-readable media storing instructions that are executable by the one or more processors to perform operations comprising:
receiving, from a computing device, a request to identify a set of mentors associated with a first test, wherein the client device is operating in a tutorial mode to administer the first test;
determining, based at least in part on a test results database, a first set of users that have passed the first test;
determining corporate data associated with individual users of the first set of users, wherein the corporate data includes at least one of a location, a department, or a manager associated with the individual users;
determining the set of mentors from the first set of users based at least in part on the corporate data and on one or more criteria; and
sending data identifying the set of mentors to the computing device.

15. The server of claim 14, wherein identifying the set of mentors from the first set of users based on the one or more criteria further comprises:
filtering the first set of users based on the one or more criteria to create first filtered users;
determining that a number of the first filtered users fails to satisfy a threshold number;
modifying the one or more criteria to create modified criteria;
filtering the first set of users based on the modified criteria to create second filtered users;
determining that the number of the second filtered users satisfies the threshold number; and
determining the set of mentors based at least in part on the second filtered users.

16. The server of claim 14, wherein the one or more criteria include at least one of a location, a department, or a manager associated with individual users of the additional users.

17. The server of claim 14, wherein the one or more criteria include at least one of a location, a department, or a manager associated with individual users of the additional users.

18. The server of claim 14, wherein the one or more criteria include a number of messages received by individual users of the additional users that are associated with the software application.

19. The server of claim 14, the operations further comprising:
receiving, from a second computing device, a request to identify a second set of mentors associated with a second test;
determining, based at least in part on the test results database, a second set of users that have passed the second test;
determining the second set of mentors from the second set of users based at least in part on second criteria; and
sending second data associated with the second set of mentors to the second computing device.

20. The server of claim 14, the operations further comprising:
determining the corporate data associated with the individual users of the first set of users from at least one of an active directory service, an email server, a conferencing server, or a corporate directory.
